(19) United States
(12) Patent Application Publication
(10) Pub. No.: US 2005/0192841 A1
(43) Pub. Date: Sep. 1, 2005

(54) Method and system for collecting information before user registration

(76) Inventors: Roy Hays, Seattle, WA (US); Billy Wayne Hensley, Garland, TX (US)

Correspondence Address: Thomas P. Liniak, Esq.;Liniak, Berenato & White, LLC, Suite 240, 6550 Rock Spring Drive, Bethesda, MD, 20817, US

(21) Appl. No.: 11/113,053

(22) Filed: Apr. 25, 2005

Related U.S. Application Data
(63) Continuation of application No. 09/654,146, filed on Sep. 1, 2000.

(51) Int. Cl. G06F 17/60

(52) U.S. Cl. 705/2

(57) ABSTRACT

A collection system for collecting medical information. The collection system comprises a collection server and multiple collection kiosks. A collection kiosk is a computer system attached to various devices for collecting medical information. The collection kiosks may be located at various locations, such as in drug stores or pharmacies. A person can use the collection kiosks to collect and store their medical information. The collection kiosks may have a user interface through which a person can enter a user identifier and password to obtain access to their stored medical information. Whenever a user wants to collect current medical information, the user would go to a collection kiosk, log on to the kiosk, and have their medical information collected and then stored.

### CROSS-REFERENCE TO ALL RELATED APPLICATIONS

This application is related to U.S. patent application Ser. No. ______ entitled “METHOD AND SYSTEM FOR DISTRIBUTING WEB CONTENT,” filed on ______, 2000 (Attorney Docket No. 181138001 US); U.S. patent application Ser. No. ______, entitled “METHOD AND SYSTEM FOR GLOBAL LOG ON IN A DISTRIBUTED SYSTEM,” filed on Jul. 17, 2000 (Attorney Docket No. 181138002 US); U.S. application Ser. No. ______, entitled “METHOD AND SYSTEM FOR COLLECTING INFORMATION AT DISTRIBUTED LOCATIONS,” filed on ______, 2000 (Attorney Docket No. 181138003 US), the disclosures of which are incorporated herein by reference.

### TECHNICAL FIELD

The described technology relates to the collection of information at distributed locations.

### BACKGROUND

The Internet comprises a vast number of computers and computer networks that are interconnected through communication links. The interconnected computers exchange information using various services, such as electronic mail, Gopher, file transfer protocol (“FTP”), and the World Wide Web (“WWW”). The WWW service allows a server computer system (i.e., web server or web site) to send graphical web pages of information to a remote client computer system. (In some instances, the server and client functionality can be hosted on a single computer.) The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page (e.g., by selecting an icon representing that web page), the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems. The content of a web page (e.g., graphic images) may be stored in a resource (e.g., file) that is separate from the web page. In particular, a web page may contain a URL that defines the resource that contains the content. When the web page is displayed, that URL is used to retrieve and then display the content.

Medical service providers and their patients have a need to monitor medical information (e.g., blood pressure readings) very closely in some circumstances. It is relatively easy for a medical service provider to collect and monitor medical information when the patient is at a medical facility (e.g., hospital) and possible for a patient to collect certain types of medical information while not at a medical facility. It has, however, been difficult for medical service providers and their patients to monitor medical information collected by the patients outside of a medical facility. For example, a patient may take their own blood pressure readings at home, but never provide those readings to their medical service provider or even record those readings so that trends can be tracked. Moreover, many patients may not even have the equipment in their homes for collecting such medical information. To facilitate the collection of medical information, blood pressure stations or kiosks have been installed at some publicly accessible locations (e.g., drug stores). Patients who do not have the equipment in their homes can use such publicly accessible kiosks to collect their medical information. Although these kiosks now make it possible for virtually all patients to collect their medical information, the tracking of such medical information over time is still as difficult as if the patient had collected the information at their home. Also, the kiosks may be installed at only a limited number of locations, in part, because the owners of those locations may not perceive the benefit of having such a kiosk. One benefit of a kiosk is that it may increase the customer traffic to those locations.

It would be desirable to have a system in which medical information could be easily collected by patients and stored in a way that both patients and medical service providers could monitor the medical information over time. It would be desirable to have a kiosk that would bring enhanced benefits to both owners of the installed locations and the patients. In addition, it would be desirable to have a system in which patients could have their medical information collected at any available kiosk and made available to the patients and to medical service providers via the Internet.

### BRIEF DESCRIPTION OF THE DRAWINGS

FIG. 1 is a diagram illustrating the main web page of the collection kiosk.

FIG. 2 is a diagram illustrating a blood pressure verification display.

FIG. 3 is a diagram illustrating an instructional web page.

FIG. 4 is a diagram illustrating a web page displayed while collecting blood pressure measurements.

FIG. 5 is a diagram illustrating a web page for displaying blood pressure measurements.

FIG. 6 is a diagram illustrating a web page asking whether the user is a member of Lifeclinic.com.

FIG. 7 is a diagram illustrating a web page for entry of log on information of a registered user.

FIG. 8 is a state diagram illustrating the display of the web pages of the collection kiosk in one embodiment.

FIG. 9 is a block diagram illustrating components of a medical information collection system in one embodiment.

FIG. 10 is a block diagram illustrating data structures of the database of a collection kiosk in one embodiment.

FIG. 11 is a flow diagram illustrating a routine for processing member log on information.

FIG. 12 is a flow diagram illustrating a routine that prepares blood pressure readings to be transferred to central medical information server.

FIG. 13 is a flow diagram illustrating a routine transfer the upload file from a collection kiosk to the central medical information server.

FIG. 14 is a flow diagram illustrating a routine of the central medical information server that processes the upload files received from the collection kiosk.

FIG. 15 is a flow diagram illustrating a routine of the central medical information server that processes the daily transactions.

### DETAILED DESCRIPTION

A method and system for collecting information from remote locations is provided. In one embodiment, the collection system includes a central repository and multiple collection kiosks. The collection kiosks collect information (e.g., blood pressure readings) from users and store the collected information locally. Periodically, the collection kiosks establish connections with the central repository and upload the collected information. The collection system then stores the uploaded information in a database. A user can then access their information that is stored in the central repository (e.g., a medical information web site) through a device, which is typically other than collection kiosks, such as a personal computer. The collection system uses an authentication mechanism, such as user identifiers and passwords, to control access to information stored in the database and to match up information collected at a collection kiosk with the previously collected data for the same user.

Users can register with the collection system either through the central repository or through the collection kiosks. A user registers at the central repository by entering a user identifier and password. If no other user uses the same user identifier, then the collection system stores the entered user identifier and password for the newly registered user. The central repository also sends user information to the collection kiosks so that each collection kiosk can maintain a list of registered users. After a collection kiosk collects information (e.g., blood pressure readings) from a user, it asks the user whether they want to save the information. If so, then the collection kiosk prompts the user for their user identifier and password. If the user is already registered, then the collection kiosk stores the collected information for later uploading to the central repository. If the user is not registered, then the collection kiosk stores the collected information, user identifier, and password for later uploading to the central repository. In this way, newly registered users can have their information stored at the central repository without having to register directly with the central repository.

In one embodiment, the collection system is implemented as part of a distributed medical information collection system. The collection system comprises a collection server and multiple collection kiosks (i.e., remote computer systems). A collection kiosk is a remote computer system attached to various devices for collecting medical information. For example, the devices may include a blood pressure monitor and a scale. The collection kiosks may be located at various locations, such as in drug stores or pharmacies. A person can use the collection kiosks to collect and store their medical information. The collection kiosks may have a user interface through which a person can enter a user identifier and password to obtain access to their locally stored medical information. Whenever a user wants to collect current medical information, the user would go to a collection kiosk, have their medical information collected, and if they want their medical information stored, then they would enter their user identifier and password.

The collection kiosks may provide a user interface that is web-based, that is uses the HTTP and the HTML protocols. The collection kiosks may use a web browser to display web pages that define the user interface. Various web pages may be provided (e.g., stored on the collection kiosk as a local web server) that allow a user to log on to the system and collect and review medical information. A collection kiosk may periodically access the collection server to upload newly collected medical information. To upload the new information, a collection kiosk connects to the collection server and transfers the new information to its folder (i.e., directory) at the collection server. In one embodiment, the collection server may function as a file transfer protocol (“FTP”) server, and each collection kiosk may function as a FTP client with their own folders on the FTP server.

The collection server may interface with a medical information web site through which a registered user can view their medical information using their own home computer and through which a medical provider can view their patients' information. The medical information stored at the medical information web site may include the information collected at the collection kiosks. Each collection kiosk may upload recently collected medical information to the medical information web site on a periodic basis. The uploaded medical information can then be added to a central medical information database. The central medical information database may contain the medical information collected through the collection kiosks and collected through other sources. In addition, the collection kiosks may maintain a list of users (e.g., user identifier and password) who are registered to access the medical information web site. In this way, the collection kiosks can correlate the collected medical information to the registered users. Also, the collection kiosk may collect medical information for users who are not yet registered and also collect a user identifier and password so that the user can automatically be registered when the medical information is later uploaded to the medical information web site.

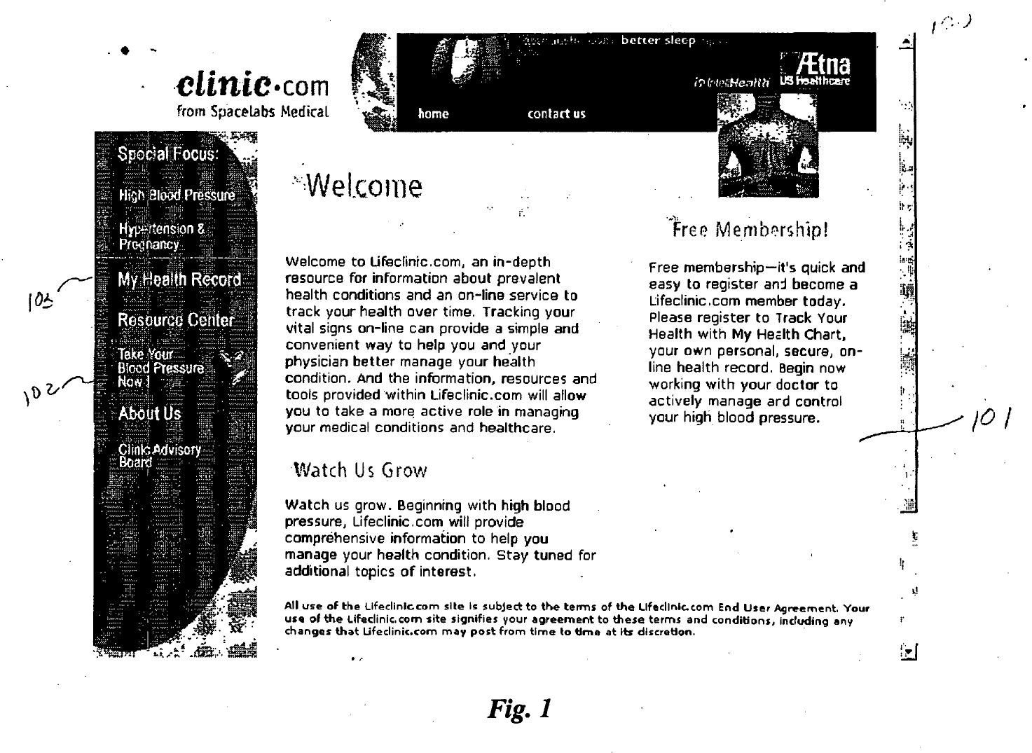

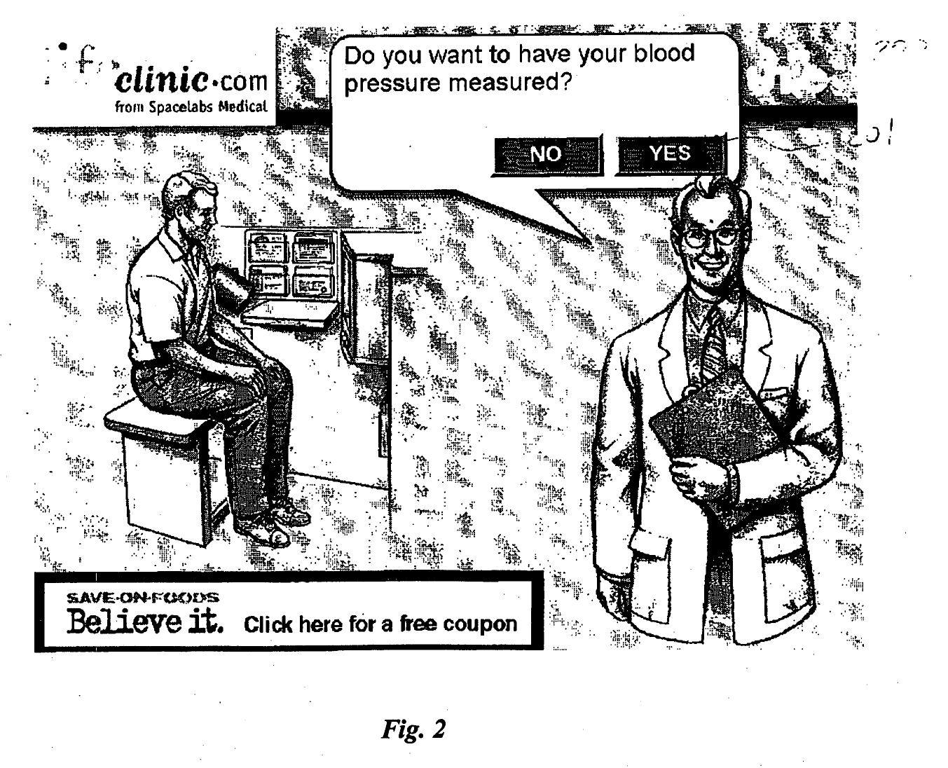

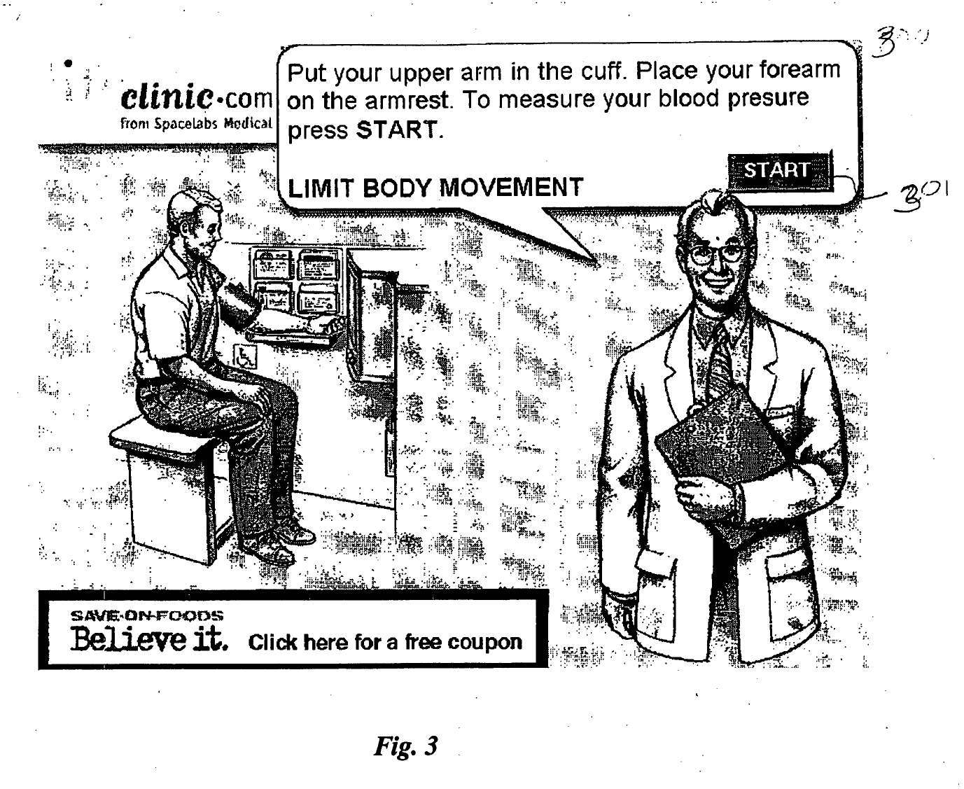

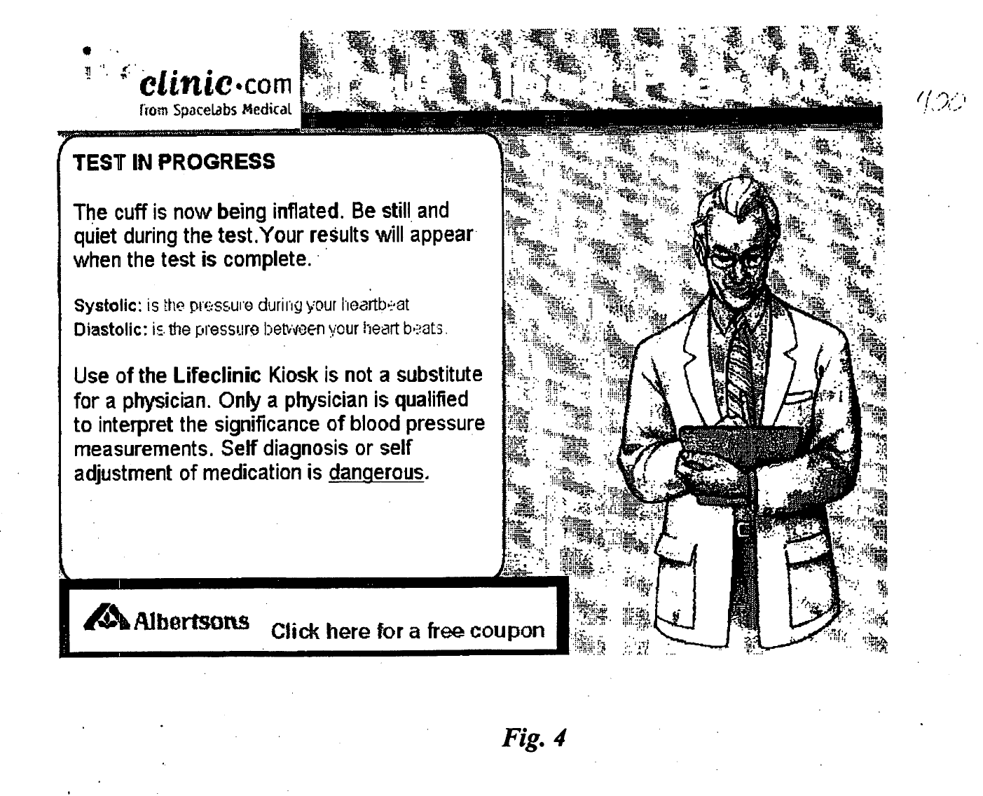

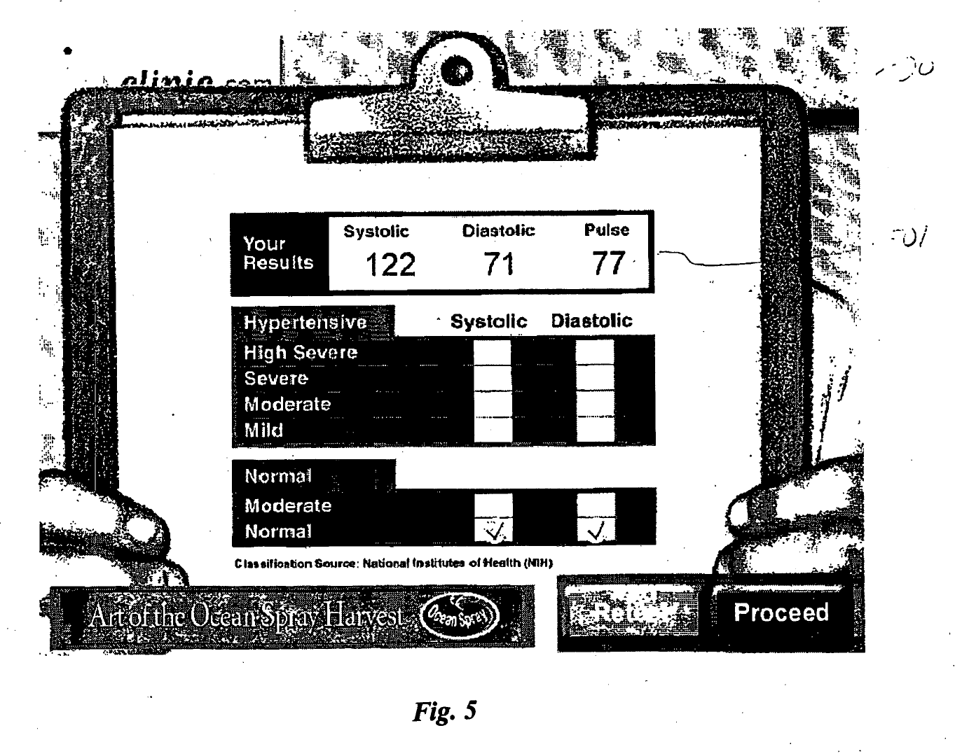

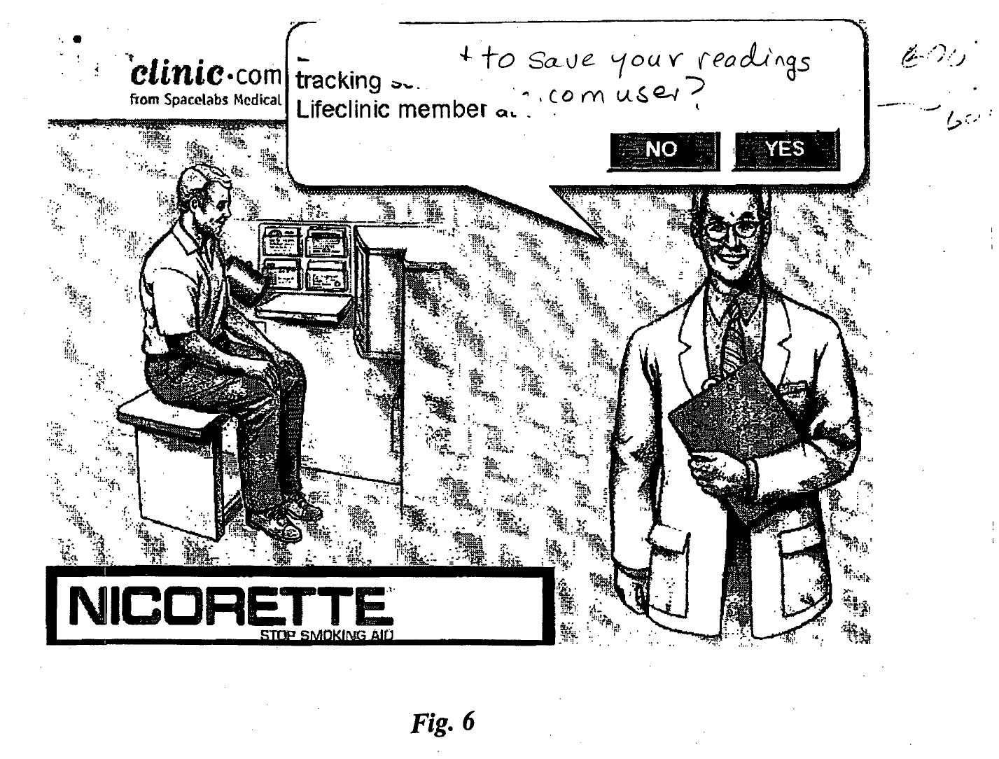

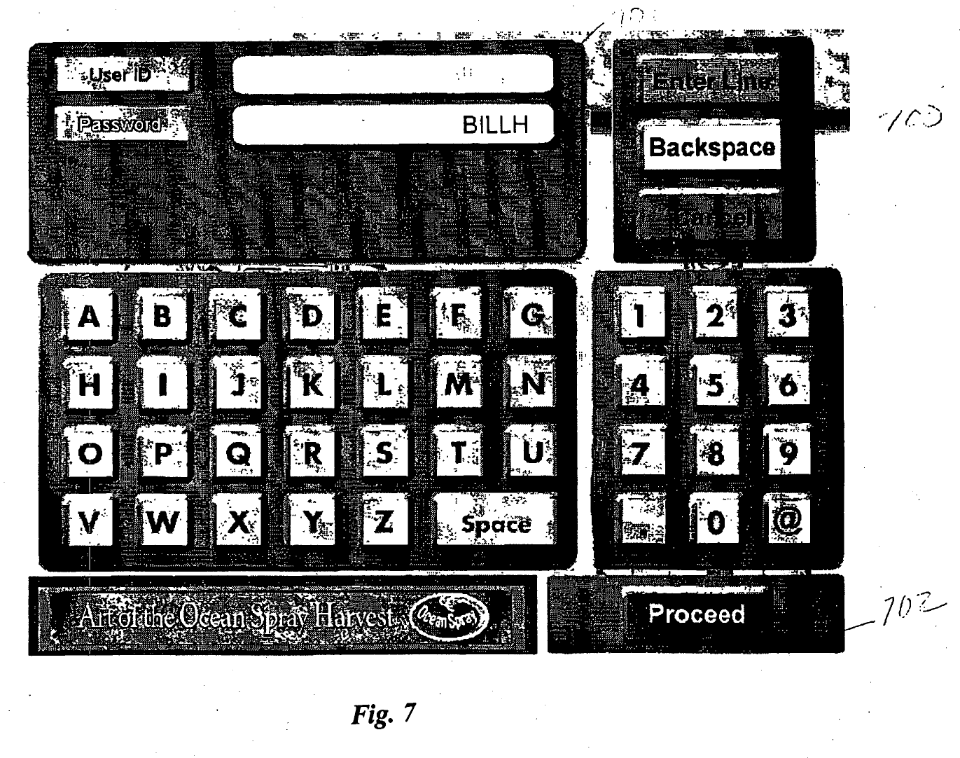

FIGS. 1-7 are diagrams illustrating the user interface of a collection kiosk in one embodiment. FIG. 1 is a diagram illustrating the main web page of the collection kiosk. The medical information web site in this embodiment is Lifeclinic.com. Web page 100 includes a general information area 101, a take blood pressure link 102, and a review health record link 103. This web page may be displayed when a user first starts to collect their medical information. The general information area describes how to become a member or registered user of Lifeclinic.com and how to use the collection kiosk. A user can select the take blood pressure link to proceed with taking their blood pressure and select the review health record link to view their medical information that has been collected at this collection kiosk. FIG. 2 is a diagram illustrating a blood pressure verification web page. Web page 200 includes dialog box 201 with buttons to verify whether the user wants to proceed with having their blood pressure measured. FIG. 3 is a diagram illustrating an instructional web page. Web page 300 includes dialog box 301. The dialog box provides instructions for taking blood pressure and includes a start button that the user selects when the user is ready to start taking their blood pressure. FIG. 4 is a diagram illustrating a web page displayed while collecting blood pressure measurements. Web page 400 includes general information about the taking of blood pressure. FIG. 5 is a diagram illustrating a web page for displaying blood pressure measurements. Web page 500 includes blood pressure display box 501 in which the recently taken blood pressure information is displayed. FIG. 6 is a diagram illustrating a web page asking the user whether to save the measurements. Web page 600 includes dialog box 601. The dialog box 601 contains information asking the user whether they want to save these measurements as a registered Lifeclinic.com user and includes buttons for indicating a response. FIG. 7 is a diagram illustrating a web page for entry of log on information of a registered user. This web page is displayed when a user indicates that they want to save these measurements. Web page 700 includes log on area 701. A user enters their user identifier and password in the log on area and then selects the proceed button 702. The collection kiosk can then determines whether the user is registered by checking its own copy of the list of registered users. The collection kiosk then stores the user's recently taken blood pressure information so that it may be eventually uploaded to the medical information server. If the user is not currently registered, then the collection kiosk stores the user identifier and password so that the user can be registered when blood pressure information is uploaded.

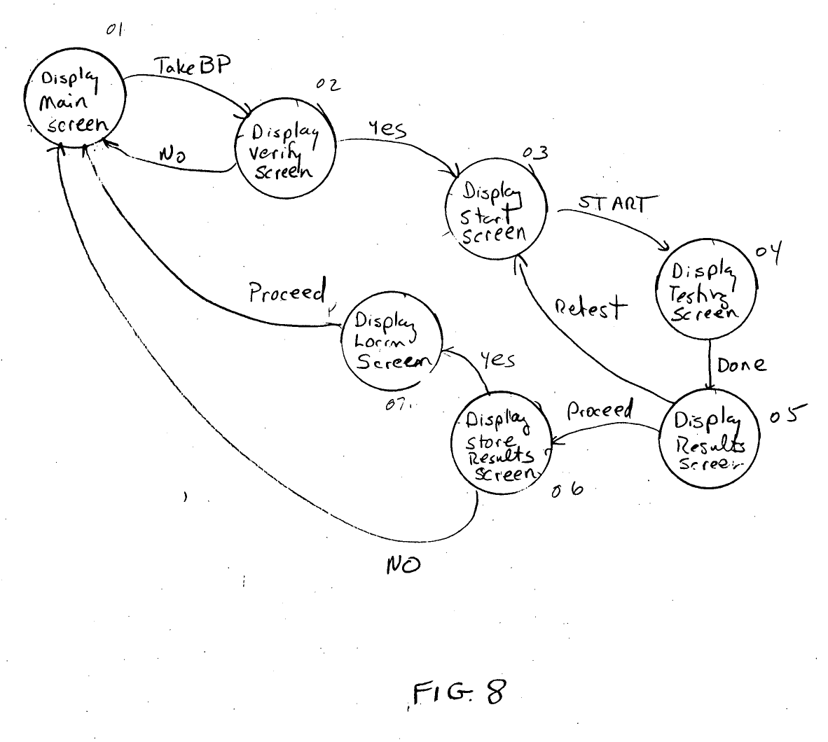

FIG. 8 is a state diagram illustrating the display of the web pages of the collection kiosk in one embodiment. Each circle 801-809 corresponds to the display of a web page and a state of the collection kiosk. The lines between the circles indicate the events that cause a transition from one state to another. Circle 801 corresponds to the display of the main web page. When the user indicates that they want to take their blood pressure now, the collection kiosk displays the verify web page as indicated by circle 802. When the user selects the “yes” response, the collection kiosk displays the start taking blood pressure web page as indicated by circle 803. When the user selects the “no” response, the collection kiosk redisplays the main web page as indicated by circle 801. When the start taking blood pressure web page is displayed and the user selects “start,” the collection kiosk displays the testing web page as indicated by circle 804. When the collection kiosk is finished collecting the blood pressure, it displays the results web pages indicated by circle 805. If the user then selects to take their blood pressure again, the collection kiosk displays the start taking blood pressure screen as represented by circle 803. If the user indicates to “proceed,” then the collection kiosk displays the store results web page as indicated by circle 806. When the user response with a “yes,” the collection kiosk then displays the log on screen as represented by circle 807. When the user enters their log on information and selects to proceed, the collection kiosk stores the blood pressure reading in association with the user's identifier and then displays the main web pages indicated by circle 801. If the user is not currently registered, then the user identifier and password are stored for later uploading to the collection server. When the store results web page is displayed and the user responds with a “no,” the collection kiosks displays the main web page as indicted by circle 801.

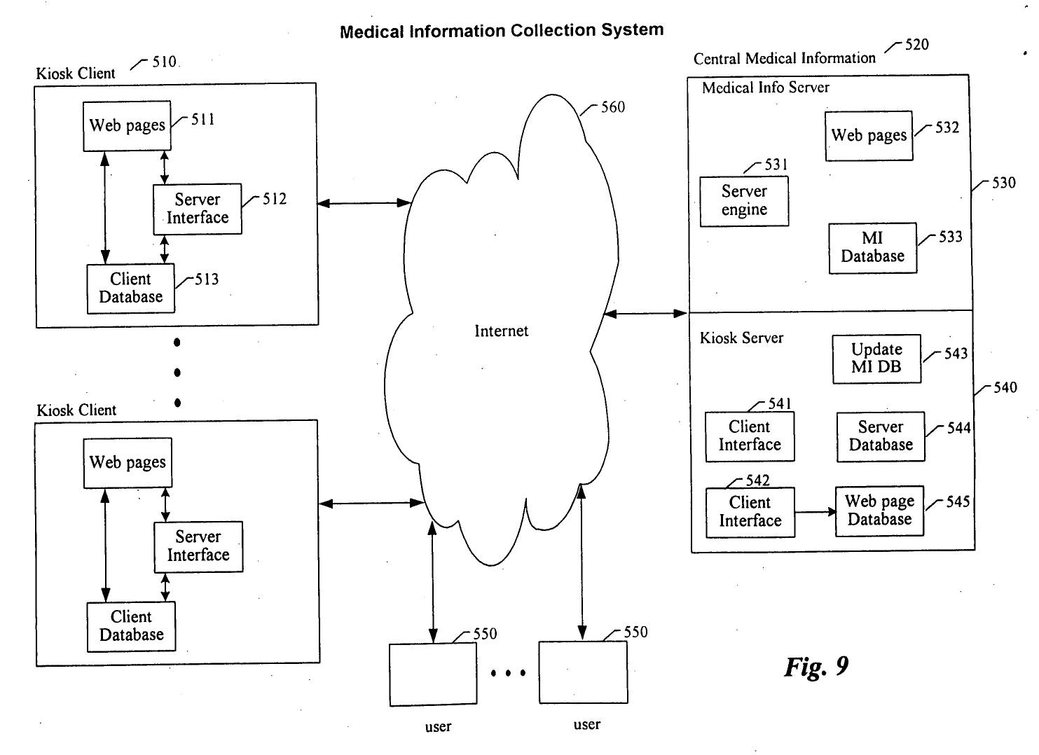

FIG. 9 is a block diagram illustrating components of a medical information collection system in one embodiment. The kiosk clients 910, the medical information system 920, and user computers 950 are interconnected via the Internet 960. The computers may include a central processing unit, memory, input devices (e.g., keyboard and pointing device), output devices (e.g., display devices), and storage devices (e.g., disk drives). The memory and storage devices are computer-readable medium that may contain computer instructions that implement the medical information collection system. In addition, the data structures and message structures may be stored or transmitted via a signal transmitted on a computer-readable media, such as a communications link. The user computers may use browsers to access web pages of the central medical information system via the Internet. One skilled in the art will appreciate that the concepts of the medical information collection system can be used in many different environments. Also, various communication channels other than the Internet may be used, such as a local area network, a wide area network, or a point-to-point dial-up connection. The computer systems may comprise any combination of hardware and software that can support web servers and browsers. In particular, the central medical information system may comprise multiple computers. The user computers may comprise any combination of hardware and software that interacts with server systems.

The kiosk clients, which are implemented at the collection kiosks, include a web browser (not shown), web pages 911, a server interface 912, and a client database 913. The web pages define the user interface for the collection kiosks. The description of these web pages (e.g., HTML documents) along with additional content (e.g., gif files) may be stored in a certain directory of the file system. A user of the collection kiosk uses the browser to browse the various web pages. The server interface is responsible for accessing the central medical information system to retrieve updated content and registered user updates. In one embodiment, the server interface acts as an FTP client to retrieve updated content and user updates from the central medical information system. The server interface may periodically (e.g., daily) established an FTP connection to retrieve the updated content and user information. The server interface stores the updated content in the web page directory to overwrite or augment existing web page content or updates a registered user table to reflect the updated user information. The client database thus contains the identification of each of the users of the central medical information system along with the medical information collected at that collection kiosk.

The central medical information system includes a medical information server 930 (e.g., Lifeclinic.com) and a kiosk server 940. The medical information server provides web pages through which users can view their medical information stored at the central medical information system. The medical information server includes a server engine 931, web pages 932, and medical information database 933. The server engine receives and responds to HTTP requests. The web pages define the user interface that is provided to the user computers. The medical information database contains the identification of the users and the collected medical data for each user. The kiosk server controls the distribution of content and update of registered users to the kiosk clients and the collection of medical information from the collection kiosks. The kiosk server includes a client interface 941, a create web page component 942, an update medical information database 943, a server database 944, and a web page database 945. The client interface includes a component to move content and user updates to be distributed to kiosk clients through various FTP directories and an FTP server to provide the updated content and user updates when requested by the FTP clients of the kiosk clients. The create web page component allows an administrator to specify the content of the various web pages and to specify which content should be distributed to which kiosk clients. The web page database contains the description of web pages and their content. The server database contains access information (e.g., URLs) for the kiosk clients. The update medical information database contains the medical information collected via the collection kiosks and awaiting to be stored in the medical information database of the medical information server. Other aspects of the medical information collection system are described in U.S. patent application Ser. No. ______ (Attorney Ref. No. 18113-8001) entitled “Method and System for Distributing Web Content” and U.S. patent application Ser. No. ______ (Attorney Ref No. 18113-8002), entitled “Method and System for Global Log On in a Distributed System.”

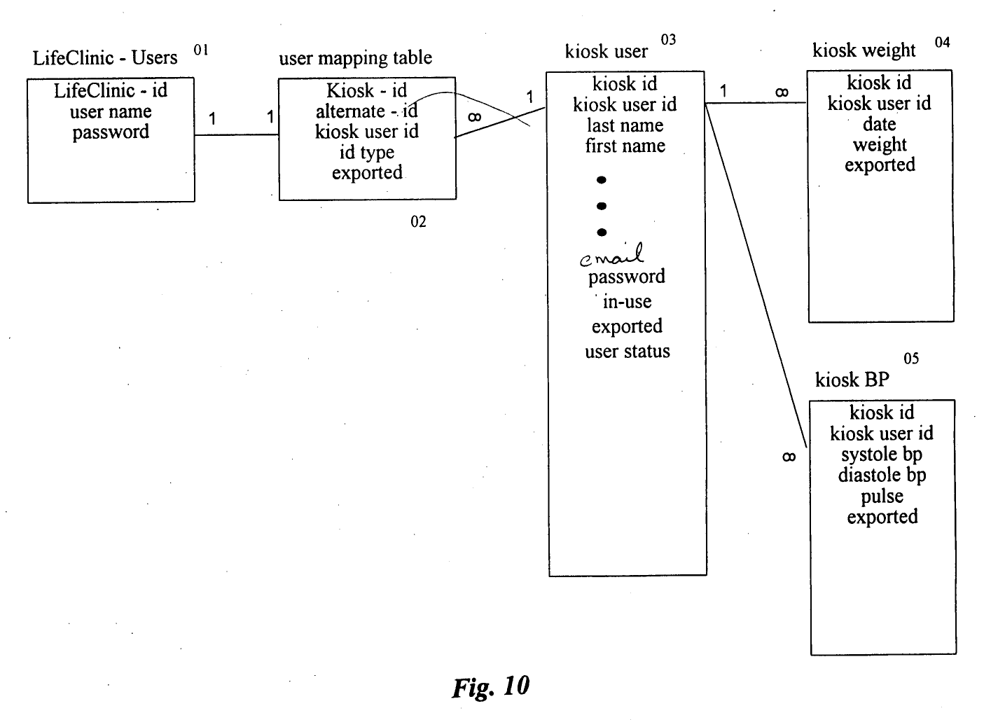

FIG. 10 is a block diagram illustrating data structures of the database of a collection kiosk in one embodiment. The collection kiosk includes a Lifeclinic user table 1001, a user mapping table 1002, a kiosk user table 1003, a kiosk weight table 1004, and a kiosk blood pressure table 1005. The Lifeclinic user table contains an entry for each registered Lifeclinic.com user. The collection kiosk updates the Lifeclinic user table when processing the update files that it retrieves from the kiosk server. The kiosk user table contains an entry for each user who has used this collection kiosk. The user mapping table contains a mapping from Lifeclinic user identifier to kiosk user identifier. That is, each Lifeclinic user who has used this collection kiosk will have a corresponding entry in the user mapping table that maps their Lifeclinic identifier to their kiosk identifier. The kiosk weight table and kiosk blood pressure table contain an entry for each blood pressure reading and weight reading for the users.

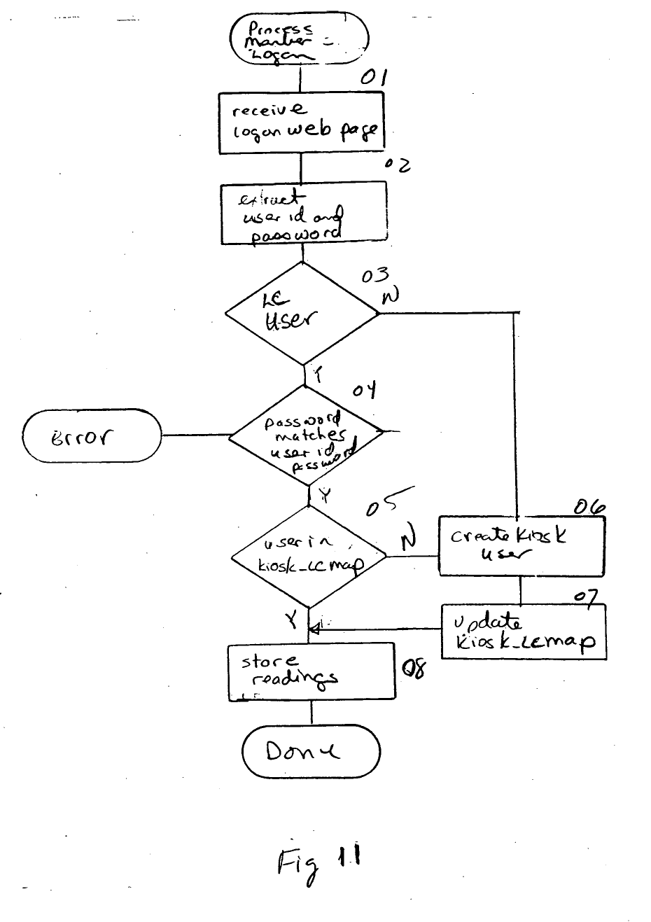

FIG. 11 is a flow diagram illustrating the routine for processing member log on information at a collection kiosk in one embodiment. This routine receives a user identifier and password and verifies whether the user is a registered Lifeclinic.com user. If the user has not previously used this collection kiosk, then the routine adds the user as a kiosk user. The routine thenstores the blood pressure readings. In block 1101, the routine receives the response to the log on web page. In block 1102, the routine extracts the user identifier and password from the received response. In decision block 1103, if the user identifier is in the Lifeclinic user table, then the user is verified as a member and the routine continues at block 1104, else the routine continues at block 1306. In decision block 1104, if the received password matches the password in the Lifeclinic user table, then the routine continues at block 1105, else the routine returns an error. In decision block 1105, if the user identifier is in the user mapping table, then the routine continues at block 1108, else the routine continues at block 1106. In block 1106, the routine creates a new kiosk user by storing an entry in the kiosk user table. In block 1107, the routine updates the user mapping table. In block 1108, the routine stores the blood pressure readings for the user and sets a flag in the kiosk user table to indicate that the readings need to be exported. The routine then completes.

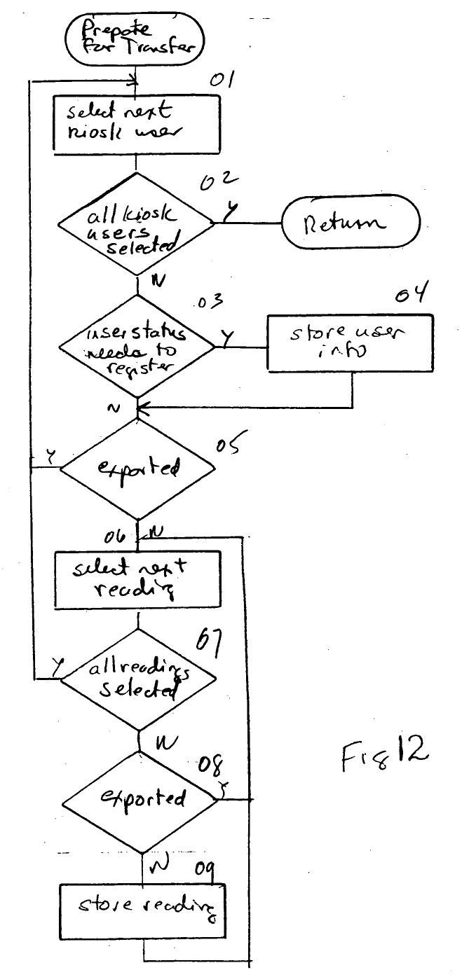

FIG. 12 is a flow diagram illustrating a routine that prepares blood pressure readings to be transferred to the central medical information server. The routine prepares the blood pressure readings for upload from the collection kiosk to the central medical information server and also prepares information for users who want to register with Lifeclinic.com for upload. In blocks 1201-1209, the routine loops processing each kiosk user. In block 1201, the routine selects the next kiosk user from the kiosk user table. In decision block 1202, if all the kiosk users have already been selected, then the routine completes, else the routine continues at block 1203. In decision block 1203, if the user status indicates that the selected user is not yet registered with Lifeclinic.com, then the routine continues at block 1204, else the routine continues at block 1205. In block 1204, the routine stores the user information for the selected user into an upload file and changes the status of the user. In decision block 1205, if all the medical readings have been exported (i.e., uploaded to the central medical information server) for the selected user as indicated by the exported flag in the kiosk user table, then the routine loops to block 1201 to select the next user, else the routine continues at block 1206. In blocks 1206-1209, the routine loops selecting each medical readings of the selected user and storing into the upload file those readings that have not yet been exported. In block 1206, the routine selects the next reading. In decision block 1207, if all the readings for the selected kiosk user have already been selected, then the routine loops to block 1201 to select the next kiosk user, else the routine continues at block 1208. In block 1208, if the selected reading has already been exported, then the routine loops to block 1206 to select the next reading, else the routine continues at block 1209. In block 1209, the routine stores the reading in the upload file and loops to block 1206 to select the next reading.

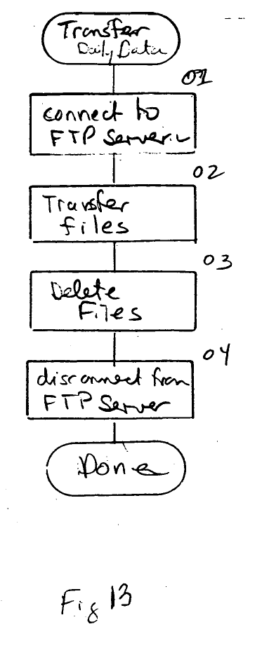

FIG. 13 is a flow diagram illustrating a routine to transfer the upload file from a collection kiosk to the central medical information server in one embodiment. In block 1301, the routine connects to the FTP server of the central medical information system. In block 1302, the routine transfers the upload files from the collection kiosk to a designated folder of the central medical information server. In block 1303, the routine deletes the upload files at the collection kiosk. In block 1304, the routine disconnects from the FTP server at the central medical information server. The routine then completes.

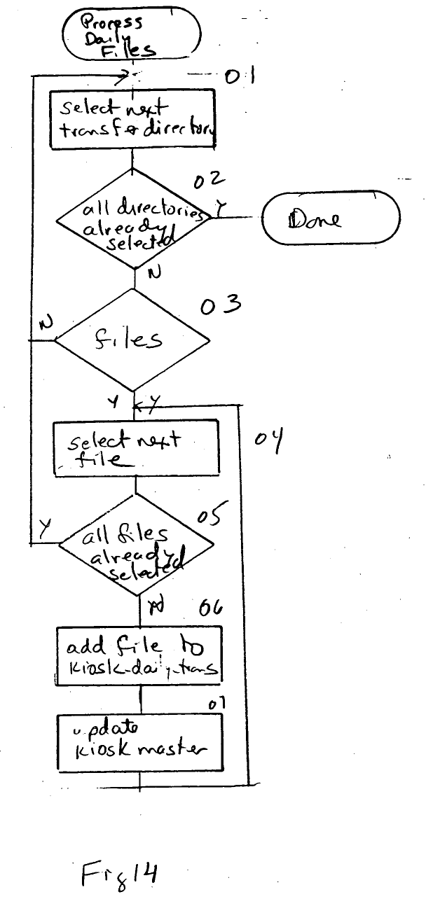

FIG. 14 is a flow diagram illustrating a routine of the kiosk server of central medical information system that processes the upload files received from the collection kiosks. Each collection kiosk has a directory assigned to it by the kiosk server. This routine checks each directory to determine whether the assigned collection kiosk has uploaded any information since the last processing of the upload files. If so, the routine transfers the data from those files to a temporary database. In blocks 1401-1407, the routine loops selecting each directory and processing the files in the directory. In block 1401, the routine selects the next directory. In decision block 1402, if all the directories have already been selected, then the routine completes, else the routine continues at block 1403. In block 1403, if there are files in the selected directory, then the routine continues at block 1404, else the routine loops to block 1401 to select the next directory. In block 1404, the routine selects the next file in the selected directory. In decision block 1405, if all the files of the selected directory have already been selected, then the routine may delete the files in the selected directory before looping to block 1401 to select the next directory, else the routine continues at block 1406. In block 1406, the routine adds the information in the selected file to a kiosk daily transaction table, which contains an entry for each file processed and is part of the temporary database. In block 1407, the routine updates a kiosk master table in the temporary database to indicate the time that the upload files for that collection kiosks were last processed and then loops to block 1404 to select the next file in the selected directory.

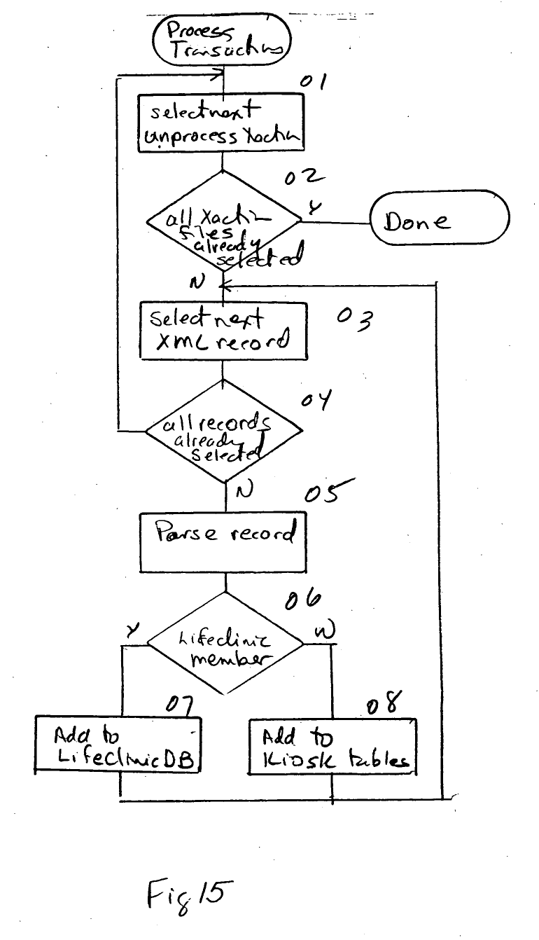

FIG. 15 is a flow diagram illustrating a routine of the kiosk server that processes the daily transactions of the kiosk daily transaction table. In block 1501, the routine selects the next unprocessed transaction. In decision block 1502, if all the transactions have already been selected, then the routine completes, else the routine continues at block 1503. In block 1503, the routine selects the next XML record for the selected transaction. In one embodiment, the information of the upload files is stored in XML format. In decision block 1504, if all the records have already been selected, then the routine loops to block 1501 to select the next unprocessed transaction, else the routine continues at block 1505. In block 1505, the routine parses the selected record. In decision block 1506, if the user is a current Lifeclinic member, then the routine continues at block 1507, else the routine continues at block 1508. In block 1508, the routine adds the readings of the selected record to the Lifeclinic database and loops to block 1503 to select the next XML record. In block 1508, the routine adds the user's information to the kiosk tables and loops to block 1503 to select the next XML record. The kiosk tables of the kiosk server correspond to the tables of the collection kiosks.

Tables 1-5 illustrate the schema of a client database stored at the collections kiosks. Table 1 represents the Lifeclinic user table and contains an entry for each Lifeclinic user. Table 2 represents the kiosk user table. This table holds basic information about a kiosk user. It contains an entry for each user of the collection kiosk. Table 3 maps Lifeclinic users to collections kiosk users. Table 4 represents the blood pressure table. Table 5 represents the kiosk weight table, which holds the weight readings taken by the collection kiosks.

TABLE 1
LIFECLINIC USER TABLE

| column | type | description |
|---|---|---|
| lifeclinic_id | text | The user's lifeclinic_id. This number is used to |
| | | internally identify the user. All of a user's data is |
| | | stored under this identifier |
| user_name | text | The name that the user uses to logon on with at |
| | | the Lifeclinic web site. |
| password | text | The password used by the user at Lifeclinic.com |

TABLE 2
KIOSK USER TABLE

| column | type | description |
|---|---|---|
| kiosk_id | number | The identification of the collection kiosk |
| kiosk_user_id | number | Unique identifier for a kiosk user. Used |
| | | internally to key user's data. |
| first_name | text | User's first name. |
| last_name | text | User's last name. |
| exported | Boolean | Indicates if this user's data has been moved to |
| | | the Lifeclinic web site. |
| user_status | number | Indicates user type. Possible values are |
| | | 1 - kiosk only, 2 - a kiosk and a Lifeclinic |
| | | user, 3 - a kiosk user who is to automatically |
| | | register as a Lifeclinic user. |

TABLE 3
USER MAPPING TABLE

| column | type | description |
|---|---|---|
| kiosk_id | number | The identification of the collection kiosk |
| alternate_id | text | An identifier that a user can use to logon with. |
| | | This identifier can be anything, such as a credit |
| | | card number, a user supplied identifier, or a |
| | | Lifeclinic id. |
| kiosk_user_id | text | The kiosk user who the alternate_id maps to. |
| id_type | number | Type of identifier stored in alternate_id. |
| | | Possible values are 0 - kiosk_user_id, |
| | | 1 - lifeclinic_id, 2 - other, 3 - login |
| | | information used to create a new lifeclinic user, |
| | | 4 - login information rejected by the server. |
| exported | Boolean | Indicates if this user's data has been moved to |
| | | the Lifeclinic web site. |

TABLE 4
BLOOD PRESSURE TABLE

| column | type | Description |
|---|---|---|
| kiosk_id | number | The identification of the collection kiosk |
| kiosk_user_id | number | Identifier of kiosk user to whom reading |
| | | belongs. |
| reading_dt | date | The date and time the reading was taken |
| systolic_bp | number | Systolic blood pressure reading. |
| diastolic_bp | number | Diastolic blood pressure reading. |
| pulse | number | Pulse rate reading. |
| exported | Boolean | Indicates if data has been moved to the |
| | | Lifeclinic web sites. |

TABLE 5
KIOSK WEIGHT TABLE

| column | type | Description |
|---|---|---|
| kiosk_id | number | The identification of the collection |
| kiosk_user_id | number | Identifier of kiosk user to whom reading |
| | | belongs. |
| reading_dt | date | The date and time the reading was taken |
| weight | number | Weight reading in pounds. |
| exported | Boolean | Indicates if data has been moved to |
| | | Lifeclinic.com |

Table 6 illustrates the format of the upload files in XML format.

TABLE 6
XML FILE FORMAT

```
<file_type>
    <table_name>
        <row>
            <column_name>column data</column_name>
            ...
        </row>
        ...
    </table_name>
    ...
</file_type>
```

Table 7 illustrates example data of a file that is uploaded from a collection kiosk.

TABLE 7
XML FILE EXAMPLE

```
<kiosk_data>
    <kc_user t=“t”>
        <row t=“r”>
            <kiosk_id t=“c”>7</kiosk_id>
            <kiosk_user_id t=“c”>91</kiosk_user_id>
            <last_name t=“c”>Estes</last_name>
            <first_name t=“c”>Stephen</first_name>
            <middle_name t=“c”></middle_name>
            <email t=“c”>sestes@mookisoft.com</email>
            <user_status t=“c”>0</user_status>
        </row>
    </kc_user>
    <kc_blood_pressure t=“t”>
        <row t=“r”>
            <kiosk_id t=“c”>7</kiosk_id>
            <kiosk_user_id t=“c”>91</kiosk_user_id>
            <reading_dt t=“c”>03/28/2000 11:06:22 AM</reading_dt>
            <systolic_bp t=“c”>120</systolic_bp>
            <diastolic_bp t=“c”>80</diastolic_bp>
            <pulse t=“c”>72</pulse>
        </row>
    </kc_blood_pressure>
</kiosk_data>
```

Based on the above description, it will be appreciated that although various embodiments of the technology have been described for purposes of illustration, various modifications may be made without deviating from the spirit and scope of the invention. For example, a collection kiosk may include a browser through which users view their medical information stored at the central repository. Accordingly, the invention is not limited except by the appended claims.

1-12. (canceled)

13. A computer-based method for registering users of a central computer system, the method comprising:
operating a measurement device attached to a remote computer system to measure and load medical information of a user who wants to register at the central computer system;
collecting at the remote computer system registration information relating to the user who wants to register at the central computer system;
sending the measured medical information and the collected registration information from the remote computer system to the central computer system;
receiving at the central computer system a request from the user to register, the request including identification data;
registering the user using the identification data; and
storing the measured medical information and the collected registration information for the user in association with the identification data included in the request.

14. The method of claim 13 wherein the request includes information for identifying the remote computer system.

15. The method of claim 13 wherein the registration information is entered by the user and includes the identification data, the identification comprising a user name and user password.

16. The method of claim 13 including measuring the blood pressure of the user at the remote computer system, the medical information including the measured blood pressure.

17. The method of claim 13 including measuring the weight of the user at the remote computer system, the medical information including the measured user weight.

18. The method of claim 13 wherein the remote computer comprises a collection kiosk.

19. A method in a remote computer system for collecting information for users who are not registered with a central computer system, the method comprising:
measuring in the remote computer system medical information of a user who wants to register at the central computer system and storing the measured medical information;
receiving registration information from the user and storing the received registration information;
determining whether the user is registered with the central computer system; and
when the user is not registered, receiving identification data from the user and sending the stored medical information and the stored registration information with the received identification data to the central computer system so that the central computer system can effect the registration of the user and association of the information with that user.

20. The method of claim 19 including when the user is not registered, asking the user whether they want to register.

21. The method of claim 19 wherein the identification data includes an electronic mail address.

22. The method of claim 19 wherein the registration information is entered by the user and includes the identification data, the identification comprising a user name and user password.

23. The method of claim 19 wherein said measuring comprises measuring the blood pressure of the user at the remote computer system, the medical information including the measured blood pressure.

24. The method of claim 19 wherein said measuring comprises measuring the weight of the user at the remote computer system, the medical information including the measured user weight.

25. The method of claim 19 wherein the remote computer comprises a collection kiosk.

26. A computer-readable medium containing instructions for controlling a remote computer system to collect information for users who are not registered with a central computer system, comprising:
computer-readable medium means in the remote computer system for measuring medical information of a user who wants to register at the central computer system and storing the measured medical information;
computer-readable medium means for receiving registration information from the user and storing the received registration information;
when the user is not registered at the central computer system, computer-readable medium means for receiving identification data from the user and sending the stored medical information and the stored registration information with the received identification data to the central computer system so that the central computer system can effect the registration of the user and association of the information with that user.

27. The computer-readable medium of claim 26 further comprising computer-readable medium means for asking the user whether they want to register.

28. The computer-readable medium of claim 26 wherein said computer-readable medium means in the remote computer system for measuring medical information of the user comprises computer-readable medium means for measuring the blood pressure of the user at the remote computer system, the medical information including the measured blood pressure.

29. The computer-readable medium of claim 26 wherein said computer-readable medium means in the remote computer system for measuring medical information of the user comprises computer-readable medium means for measuring the weight of the user at the remote computer system, the medical information including the measured user weight.
